(19) United States
(12) Patent Application Publication
(10) Pub. No.: US 2014/0198021 A1
(43) Pub. Date: Jul. 17, 2014

(54) DISPLAY DRIVING APPARATUS

(71) Applicant: Novatek Microelectronics Corp., Hsinchu (TW)

(72) Inventors: Chao-Kai Tu, Hsinchu City (TW); Kuang-Feng Sung, Taichung City (TW); Shun-Hsun Yang, Hsinchu City (TW); Teng-Jui Yu, Taoyuan County (TW)

(21) Appl. No.: 13/939,194

(22) Filed: Jul. 11, 2013

(30) Foreign Application Priority Data
Jan. 14, 2013 (TW) 102101360

(51) Int. Cl. G09G 3/36

(52) U.S. Cl. CPC G09G 3/3611
USPC 345/87

(57) ABSTRACT

A display driving apparatus, including an image processor, a timing controller, and a plurality of source drivers, is provided. The image processor determines whether an image frame corresponding to a frame data is a static image and outputs the frame data and a determination result. The timing controller receives the frame data from the image processor and outputs the frame data. The source drivers receive the frame data from the timing controller and drive a display panel according to the frame data. Each of the source drivers includes a memory module configured to store the frame data corresponding to the static image. When the source drivers drive the display panel according to the frame data corresponding to the static image, the image processor stops outputting the frame data to the timing controller, and the timing controller stops outputting the frame data to the source drivers.

### CROSS-REFERENCE TO RELATED APPLICATION

This application claims the priority benefit of Taiwan application serial no. 102101360, filed on Jan. 14, 2013. The entirety of the above-mentioned patent application is hereby incorporated by reference herein and made a part of this specification.

### BACKGROUND OF THE INVENTION

1. Field of the Invention

The invention relates to a driving apparatus and particularly relates to a display driving apparatus.

2. Description of Related Art

A liquid crystal display (LCD) is thin and light and has the characteristics of low power consumption and no radiation pollution, and therefore has been extensively applied on various IT products, such as computer systems, mobile phones, personal digital assistants (PDA), etc. The operation of the liquid crystal display relies on the following. Liquid crystal molecules generate different polarization or refraction effects on light in different arrangements. Thus, the liquid crystal molecules may be arranged differently to control the transmittance of light, so as to generate output lights having different intensities and red, green, and blue lights having different grey-scale intensities.

To execute the aforementioned operation for displaying images, typically a timing controller, a gate driver, and a source driver are used to drive the liquid crystal display. In order to process the images, the conventional technique is to configure a memory in the timing controller. When the liquid crystal display displays a static image, the timing controller and the source driver still transmit frame data to each other and thus consume power.

### SUMMARY OF THE INVENTION

The invention provides a display driving apparatus that achieves power saving.

The invention provides a display driving apparatus for driving a display panel. The display driving apparatus includes an image processor, a timing controller, and a plurality of source drivers. The image processor determines whether an image frame corresponding to a frame data is a static image and outputs the frame data and a determination result. The timing controller is coupled to the image processor for receiving the frame data from the image processor and outputting the frame data. The source drivers are coupled to the timing controller for receiving the frame data from the timing controller and driving the display panel according to the frame data. Each of the source drivers includes a memory module configured to store the frame data corresponding to the static image. When the source drivers drive the display panel according to the frame data corresponding to the static image, the image processor stops outputting the frame data to the timing controller, and the timing controller stops outputting the frame data to the source drivers.

In an embodiment of the invention, each of the memory modules includes an image processing circuit and a memory circuit. The image processing circuit is coupled to the timing controller for performing a first image process on the frame data and outputting the frame data processed by the first image process. The memory circuit is coupled to the image processing circuit for storing the frame data processed by the first image process.

In an embodiment of the invention, when each of the source drivers drives the display panel according to the frame data, the image processing circuit reads the frame data from the memory circuit and performs a second image process on the frame data.

In an embodiment of the invention, the memory modules further store frame data corresponding to a dynamic image.

In an embodiment of the invention, each of the source drivers further includes a multiplexer circuit. The multiplexer circuit is coupled to the timing controller for selecting whether to output the frame data corresponding to the dynamic image or output the frame data corresponding to the static image to drive the display panel according to a control signal.

In an embodiment of the invention, the image processor outputs the control signal to control the multiplexer circuit according to the determination result.

In an embodiment of the invention, each of the source drivers further includes a multiplexer controller. The multiplexer controller is coupled to the timing controller for determining whether the image frame corresponding to the frame data outputted by the timing controller is the static image and outputting the control signal to control the multiplexer circuit according to the determination result.

In an embodiment of the invention, each of the memory modules includes an image processing circuit and a memory circuit. The image processing circuit is coupled to the timing controller for performing a first image process on the frame data and outputting the frame data processed by the first image process. The memory circuit is coupled to the image processing circuit for storing the frame data processed by the first image process. When the multiplexer circuit selects to output the frame data corresponding to the static image, the image processing circuit reads the frame data from the memory circuit, performs a second image process on the frame data, and outputs the frame data processed by the second image process.

In an embodiment of the invention, each of the source drivers further includes a gamma voltage output circuit. The gamma voltage output circuit is coupled to the timing controller for receiving the frame data from the timing controller and outputting a gamma voltage signal corresponding to the frame data to drive the display panel. Each of the source drivers controls the gamma voltage output circuit therein according to the frame data to adjust the gamma voltage signal.

In an embodiment of the invention, the display driving apparatus and the display panel are disposed in an image display device. The image display device includes a light source module for providing a backlight source to the display panel. Each of the source drivers controls the light source module according to the frame data to adjust a brightness of the backlight source.

Based on the above, in the exemplary embodiments of the invention, each of the source drivers stores the frame data in the memory module therein. Therefore, when the display panel displays the static image, the image processor and the timing controller respectively stop outputting the corresponding frame data to the timing controller and the source drivers.

To make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a block diagram illustrating a display driving apparatus according to an example related to the invention.

FIG. 2 is a block diagram illustrating a display driving apparatus according to an embodiment of the invention.

FIG. 3 is a block diagram illustrating a source driver according to an embodiment of the invention.

FIG. 4 is a block diagram illustrating a source driver according to another embodiment of the invention.

FIG. 5 is a block diagram illustrating an image display device according to an embodiment of the invention.

### DESCRIPTION OF THE EMBODIMENTS

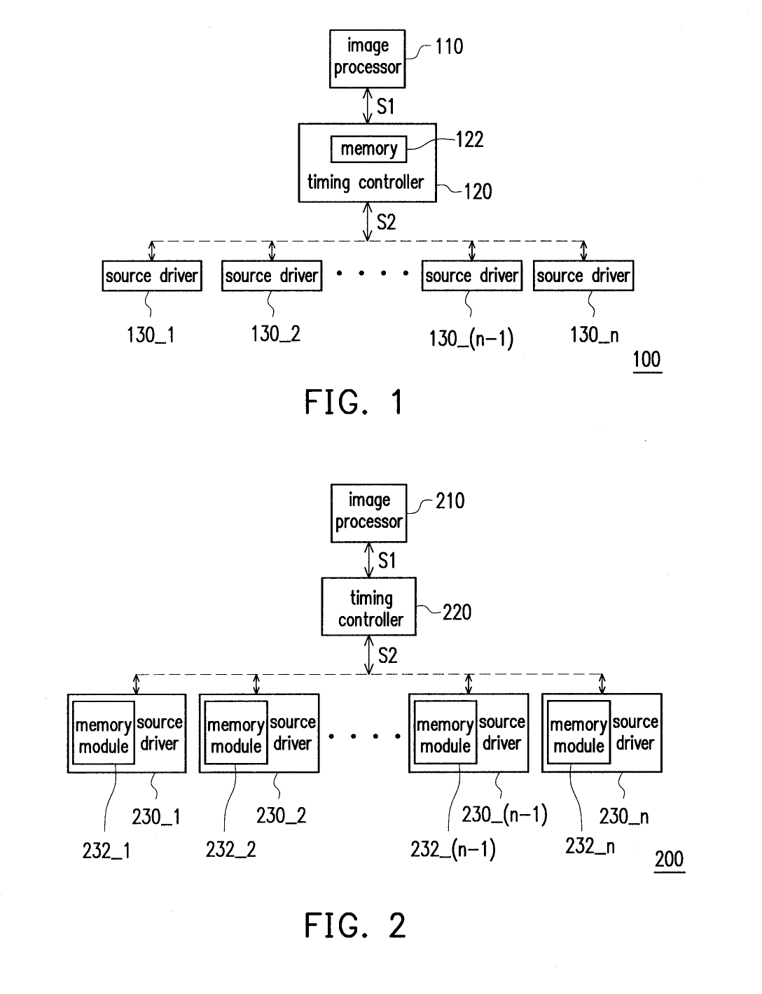

FIG. 1 is a block diagram illustrating a display driving apparatus according to an example related to the invention. Referring to FIG. 1, a display driving apparatus 100 of the related example includes an image processor 110, a timing controller 120, and a plurality of source drivers 130_1 to 130_n for driving a display panel (not shown). The display driving apparatus 100 supports a panel self refresh (PSR) function. In order to support such a function, the timing controller 120 needs to include a memory 122 therein for storing a static image. Accordingly, when the image is static, the image processor 110 may store the static image into the memory 122 of the timing controller 120. Then, the image processor 110 stops outputting frame data S1 to the timing controller 120, and the timing controller 120 directly provides static frame data S2 stored in the memory 122 to the source drivers 130_1 to 130_n, so as to reduce power consumption of the image processor 110. Since the timing controller 120 and the source drivers 130_1 to 130_n are in a state of continuously transmitting frame data, the aforementioned operation significantly increases power consumption of the timing controller 120.

FIG. 2 is a block diagram illustrating a display driving apparatus according to an embodiment of the invention. Referring to FIG. 2, a display driving apparatus 200 of this embodiment includes an image processor 210, a timing controller 220, and a plurality of source drivers 230_1 to 230_n. The image processor 210 is configured for determining whether an image frame corresponding to the frame data S1 is a static image and outputting the frame data S1 to the timing controller 220. The timing controller 220 is coupled to the image processor 210 and configured for receiving the frame data S1 from the image processor 210 and respectively outputting frame data S2 to the source drivers 230_1 to 230_n. The source drivers 230_1 to 230_n are coupled to the timing controller 220 and configured for receiving the frame data S2 from the timing controller 220 and driving a display panel (not shown) according to the frame data S2.

More specifically, in this embodiment, each of the source drivers 230_1 to 230_n includes a memory module 232_1 to 232_n configured to store the frame data S2 corresponding to the static image. When the source drivers 232_1 to 232_n drive the display panel according to the static frame data S2, the image processor 210 of this embodiment stops outputting the frame data S1 to the timing controller 220, and the timing controller 220 stops outputting the frame data S2 to the source drivers 232_1 to 232_n, so as to reduce the overall power consumption of the display driving apparatus 200. To be more specific, in comparison with the display driving apparatus 100 of FIG. 1, the timing controller 220 of this embodiment is not provided with a storage device corresponding to the memory 122. Instead, the source drivers 230_1 to 230_n of this embodiment respectively include the memory modules 232_1 to 232_n. The memory modules 232_1 to 232_n allow the image processor 210 to respectively store the static frame data S2 to the source drivers 230_1 to 230_n when the image is static. Therefore, the image processor 210 may stop outputting the frame data S1 corresponding to the static image to the timing controller 210 and stop outputting the frame data S2 corresponding to the static image to the source drivers 230_1 to 230_n, for the source drivers 230_1 to 230_n to directly use the stored static frame data S2 to drive the display panel, thereby reducing the overall power consumption of the image processor 210 and the timing controller 220.

It should be noted that, in this embodiment, the memory modules 232_1 to 232_n of the source drivers 230_1 to 230_n are not limited to storing the frame data corresponding to the static image and may also be used to store frame data corresponding to a dynamic image.

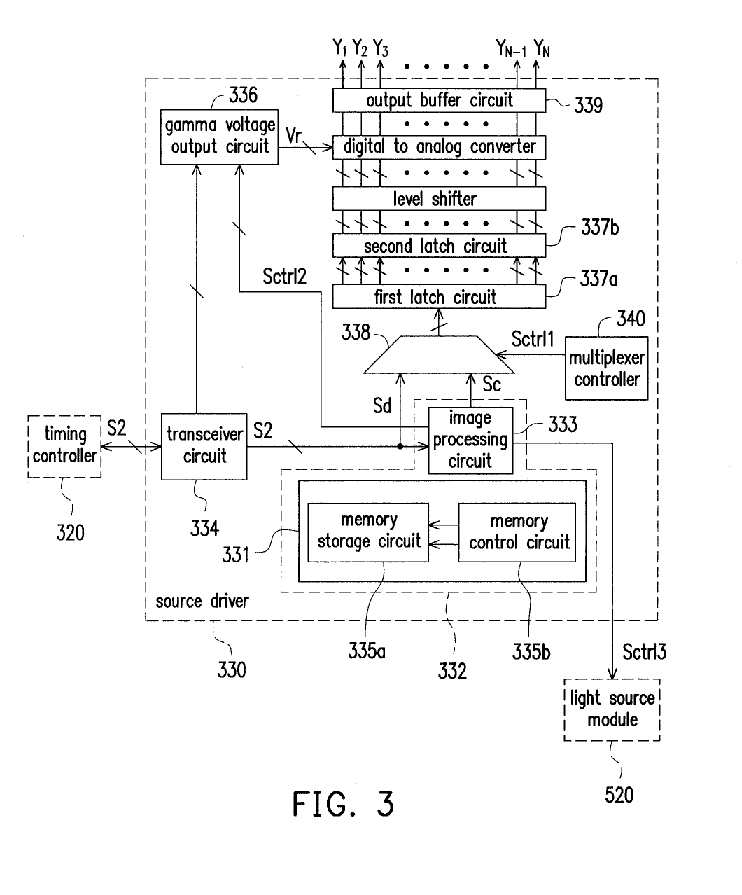

FIG. 3 is a block diagram illustrating a source driver according to an embodiment of the invention. Referring to FIG. 3, a source driver 330 of this embodiment includes a memory module 332, a transceiver circuit 334, a gamma voltage output circuit 336, a multiplexer circuit 338, and a multiplexer controller 340. The transceiver circuit 334 is coupled to the timing controller 320 for receiving the frame data S2 outputted from the timing controller 320 and outputting the received frame data S2 to a circuit of the next level, wherein the frame data S2 includes R, G, B pixel data or other display information. In this embodiment, by judging whether the frame data S2 corresponds to a dynamic image or a static image, the source driver 330 determines whether to select the static image stored in the memory module 332 to drive the display panel.

More specifically, the multiplexer controller 340 of this embodiment is configured for determining whether the image frame corresponding to the frame data S2 is static and outputting a control signal Sctrl1 to control the multiplexer circuit 338 according to a determination result. The multiplexer circuit 338 is configured for selecting whether to output the frame data corresponding to the dynamic image or output the frame data corresponding to the static image to drive the display panel according to the control signal Sctrl1. Upon determination, if the frame data S2 corresponds to the dynamic image, the multiplexer circuit 338 outputs dynamic frame data Sd and sequentially stores frame data Sd to a first latch circuit 337a and a second latch circuit 337b via a data bus. Then, an output buffer circuit 339 outputs pixel data Y₁ to Y_{N} to drive the panel. On the contrary, if the frame data S2 corresponds to the static image, the multiplexer circuit 338 outputs static frame data Sc to drive the display panel.

It should be noted that the frame data S2 to be determined by the multiplexer controller 340 may be provided by the transceiver circuit 334 in the source driver 330 or by the timing controller 320 outside. In addition, although the control signal Sctrl1 in this embodiment is generated by the multiplexer controller 340, the invention is not limited thereto. In another embodiment, the source driver 330 may not be equipped with the multiplexer controller 340 and may directly use the image processor 210 of FIG. 2, for example, to generate the control signal Sctrl1. That is to say, the image processor 210 may also be used to determine whether the image frame corresponding to the frame data S2 is the static image and then output the control signal Sctrl1 according to the determination result.

An operation of the source driver 330 that is performed when the frame data S2 corresponds to the static image is further explained below. In this embodiment, the memory module 332 further includes an image processing circuit 333 and a memory circuit 331. The image processing circuit 333 is configured for performing a first image process on the frame data S2. Here, the first image process refers to image processing, such as compressing frame data or adjusting contrast, resolution, color saturation, and brightness, etc., of the frame data. Moreover, the image processing circuit 333 stores the processed frame data into the memory circuit 331. In this embodiment, the memory circuit 331 includes a memory storage circuit 335a and a memory control circuit 335b. The memory storage circuit 335a is configured for storing the frame data, and the memory control circuit 335b is configured for controlling and managing reading/writing operation and storage blocks of the frame data. Next, when the multiplexer circuit 338 selects to output the frame data Sc corresponding to the static image, the image processing circuit 333 reads the frame data from the memory storage circuit 335a and performs a second image process on the read frame data Sc, and then outputs the processed frame data Sc to the multiplexer circuit 338.

It should be noted that the second image process may be selectively performed. For example, if the image processing circuit 333 stores the frame data S2 after compressing the frame data S2, when the frame data Sc is read, the image processing circuit 333 first decompresses the frame data Sc and then outputs the decompressed frame data Sc to the multiplexer circuit 338. However, in the case that the image processing circuit 333 performs the first image process, such as adjusting the contrast, resolution, color saturation, and brightness, etc., of the frame data S2, the second image process may be selectively performed.

Moreover, the gamma voltage output circuit 336 is configured for receiving the frame data S2 from the timing controller 320 and outputting a gamma voltage signal Vr corresponding to different frame data to drive the display panel. In this embodiment, the image processing circuit 333 may also use a control signal Sctrl2 to control the gamma voltage output circuit 336 according to the frame data S2, so as to adjust the outputted gamma voltage signal Vr, thereby achieving the effect of power saving.

Therefore, in this embodiment, the source driver 330 includes the memory module 332 for storing the frame data corresponding to the static image. When the source driver 330 drives the display panel according to the frame data corresponding to the static image, the image processor (not shown) stops outputting the frame data to the timing controller 320, and the timing controller 320 stops outputting the frame data to the source driver 330, so as to reduce the overall power consumption of the image processor 310 and the timing controller 320.

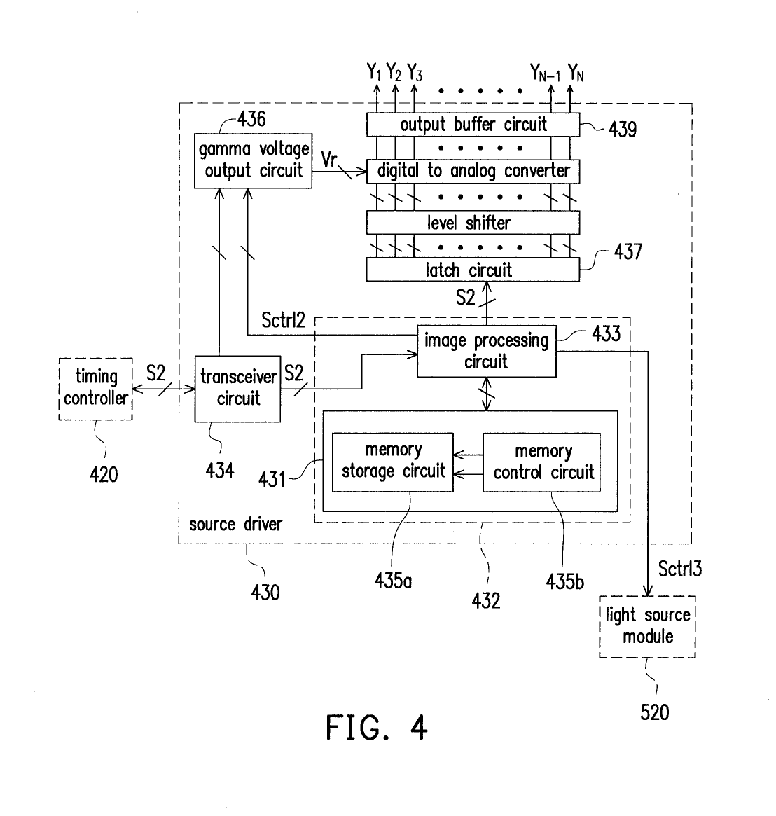

FIG. 4 is a block diagram illustrating a source driver according to another embodiment of the invention. Referring to FIG. 3 and FIG. 4, a source driver 430 of this embodiment is similar to the source driver 330 of FIG. 3, and a main difference is that the source driver 430 is provided with a multiplexer circuit and a multiplexer controller, for example. In this embodiment, according to the actual requirements, the source driver 430 does not determine whether the frame data S2 corresponds to the dynamic image or the static image. A memory module 432 performs operations of image processing and data storing on the frame data S2 no matter the frame data S2 corresponds to the dynamic image or the static image. Therefore, in this embodiment, the memory module 432 is also used for storing the frame data S2 corresponding to the dynamic image. An image processing circuit 433 stores the frame data S2 to a latch circuit 437 via a data bus. Then, an output buffer circuit 439 outputs pixel data Y₁ to Y_{N} to drive the panel.

In addition, other operations of the source driver 430 of this embodiment can be understood with reference to the teaching, disclosure, and explanation of the embodiment of FIG. 3 and thus will not be described hereinafter.

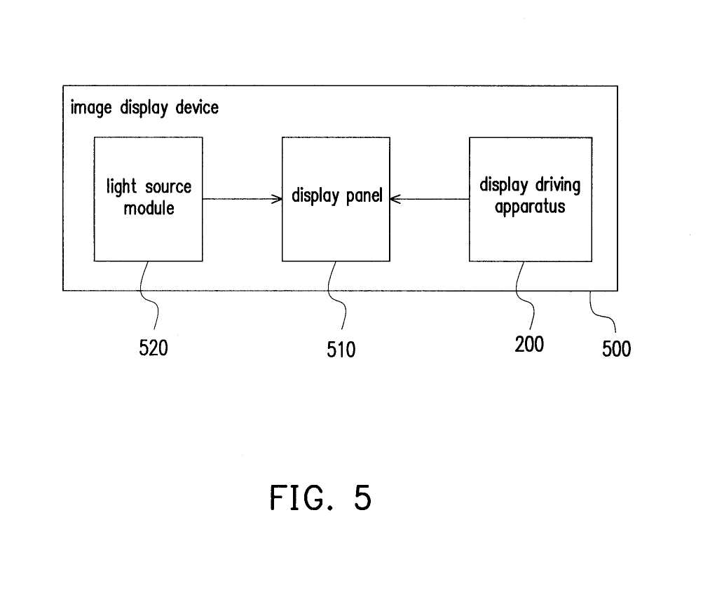

FIG. 5 is a block diagram illustrating an image display device according to an embodiment of the invention. Referring to FIG. 2 and FIG. 5, an image display device 500 of this embodiment includes the display driving apparatus 200, a display panel 510, and a light source module 520. The display driving apparatus 200 is configured for driving the display panel 510 to display the image frame corresponding to the frame data S2. The light source module 520 is for example a light emitting diode backlight module configured for providing a backlight source for the display panel 510 to display the image frame.

According to this embodiment, the source drivers 230_1 to 230_n of the display driving apparatus 200 may have the circuit structures disclosed in FIG. 3 and FIG. 4, for example. In order to achieve power saving, each of the source drivers of the display driving apparatus 200 controls the light source module 520 according to the frame data, so as to adjust the brightness of the provided backlight source. For example, lower brightness may be required when the display panel 510 displays the static image. Thus, the image processing circuits 333 and 433 may turn off a portion of light emitting diodes in the light source module 520 through a control signal Sctrl3 according to the image characteristics of the frame data S2, so as to reduce the brightness of the backlight source and achieve power saving.

In conclusion of the above, in the exemplary embodiments of the invention, the source driver includes the memory module for storing the frame data. When the source driver drives the display panel according to the frame data corresponding to the static image, the image processor stops outputting the frame data to the timing controller, and the timing controller also stops outputting the frame data to the source driver, thereby reducing the power consumption of the image processor and the timing controller.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A display driving apparatus, adapted for driving a display panel, the display driving apparatus comprising:
an image processor determining whether an image frame corresponding to a frame data is a static image and outputting the frame data and a determination result;
a timing controller coupled to the image processor and receiving the frame data from the image processor and outputting the frame data; and
a plurality of source drivers coupled to the timing controller and receiving the frame data from the timing controller and driving the display panel according to the frame data, wherein each of the source drivers comprises a memory module, and the memory modules are configured to store the frame data corresponding to the static image,
wherein when the source drivers drive the display panel according to the frame data corresponding to the static image, the image processor stops outputting the frame data to the timing controller, and the timing controller stops outputting the frame data to the source drivers.

2. The display driving apparatus according to claim 1, wherein each of the memory modules comprises:
an image processing circuit coupled to the timing controller and performing a first image process on the frame data and outputting the frame data processed by the first image process; and
a memory circuit coupled to the image processing circuit and storing the frame data processed by the first image process.

3. The display driving apparatus according to claim 2, wherein, when each of the source drivers drives the display panel according to the frame data, the image processing circuit reads the frame data from the memory circuit and performs a second image process on the frame data.

4. The display driving apparatus according to claim 1, wherein the memory modules further store a frame data corresponding to a dynamic image.

5. The display driving apparatus according to claim 1, wherein each of the source drivers further comprises:
a multiplexer circuit coupled to the timing controller and selecting whether to output the frame data corresponding to the dynamic image or output the frame data corresponding to the static image to drive the display panel according to a control signal.

6. The display driving apparatus according to claim 5, wherein the image processor outputs the control signal to control the multiplexer circuit according to the determination result.

7. The display driving apparatus according to claim 5, wherein each of the source drivers further comprises:
a multiplexer controller coupled to the timing controller and determining whether the image frame corresponding to the frame data outputted by the timing controller is the static image and outputting the control signal to control the multiplexer circuit according to the determination result.

8. The display driving apparatus according to claim 5, wherein each of the memory modules comprises:
an image processing circuit coupled to the timing controller and performing a first image process on the frame data and outputting the frame data processed by the first image process; and
a memory circuit coupled to the image processing circuit and storing the frame data processed by the first image process,
wherein, when the multiplexer circuit selects to output the frame data corresponding to the static image, the image processing circuit reads the frame data from the memory circuit, performs a second image process on the frame data, and outputs the frame data processed by the second image process.

9. The display driving apparatus according to claim 1, wherein each of the source drivers further comprises:
a gamma voltage output circuit coupled to the timing controller and receiving the frame data from the timing controller and outputting a gamma voltage signal corresponding to the frame data to drive the display panel,
wherein each of the source drivers controls the gamma voltage output circuit therein according to the frame data to adjust the gamma voltage signal.

10. The display driving apparatus according to claim 1, wherein the display driving apparatus and the display panel are disposed in an image display device which comprises a light source module for providing a backlight source to the display panel, wherein each of the source drivers controls the light source module according to the frame data to adjust a brightness of the backlight source.
